(19) United States
(12) Patent Application Publication
(10) Pub. No.: US 2010/0188295 A1
(43) Pub. Date: Jul. 29, 2010

(54) Electronic device and antenna module

(75) Inventor: Rong-Cheng Sun, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: Wistron Corporation, Taipei Hsien (TW)

(21) Appl. No.: 12/591,766

(22) Filed: Dec. 1, 2009

(30) Foreign Application Priority Data
Jan. 23, 2009 (TW) 098102776

(51) Int. Cl. H01Q 5/00; H01Q 1/38; H01Q 1/24

(52) U.S. Cl. 343/700 MS; 343/702

(57) ABSTRACT

An antenna module for wireless signal transmission of an electronic device is disclosed. The antenna module comprises a main body and a feed point. The main body is a rectangular metal sheet and comprises a hollow portion. The hollow portion extends inwardly from one side of the main body. The main body may be separated by the hollow portion to form a first radiating portion, a second radiating portion, and a third radiating portion. The feed point is connected to a feed line, and is used for feeding an electrical signal to the main body, such that the first radiating portion forms a first current path, the second radiating portion forms a second current path, and the third radiating portion combined with the second radiating portion forms a third current path so as to generate different operating bands.

### BACKGROUND OF THE INVENTION

1. Field of the Invention

The present invention relates to an antenna module; more particularly, to a downsized and simplified multi-band antenna module.

2. Description of the Related Art

With the development of wireless transmission technology, a user can connect to the interne at any time and any place via a portable electronic device with wireless transmission function, such as a laptop computer, a cellular phone, or a personal digital assistant (PDA), so as to facilitate the user's daily activities. Generally, an antenna module is installed in the portable electronic device, such that the antenna module can receive/transmit signals to provide the wireless transmission function. Because the portable electronic device is characterized by its portability, its structure has to be designed in a compact size, and the size of the antenna module has to be reduced as well. However, if the size of the antenna module is reduced, its reception efficiency is usually reduced accordingly. On the other hand, in order to provide an antenna module capable of accommodating to the transmission bandwidths and efficiency of different systems, the corresponding structure design of each component of the antenna module has to be taken into consideration. As a result, the structure complexity of the antenna module will be increased, with resultant increases to its manufacturing cost. It is important to provide a compact-sized antenna module capable of supporting a multi-band transmission function.

Therefore, there is a need to provide an electronic device and antenna module to mitigate and/or obviate the aforementioned problems.

### SUMMARY OF THE INVENTION

A main objective of the present invention is to provide a simplified antenna module capable of supporting a multi-band function.

In order to achieve the aforementioned objective, an antenna module of the present invention is applied to an electronic device for transmitting wireless signals. The antenna module of the present invention comprises a main body and a feed point. The main body is a rectangular metal sheet and comprises a hollow portion. The hollow portion extends inwardly from one side of the main body, such that the main body is separated by the hollow portion to form a first radiating portion, a second radiating portion, and a third radiating portion. The feed point is connected to a feed line and is used for feeding an electrical signal to the main body. Accordingly, the first radiating portion forms a first current path, the second radiating portion forms a second current path, and the third radiating portion, combined with the second radiating portion, forms a third current path, so as to generate different operating bands. The hollow portion comprises an opening, which is located between the first radiating portion and the third radiating portion. The shape of the hollow portion is substantially similar to the English letter Z, the English letter S, or the Arabic numeral 2. According to the corresponding design of the shape of the hollow portion and the position of its opening, the antenna module of the present invention is capable of operation according to the Worldwide Inter-operability for Microwave Access (WiMAX) standards.

In another implementation of the antenna module of the present invention, according to the corresponding design of the shape of the hollow portion and the position of its opening, the main body is separated by the hollow portion to form a first radiating portion, a second radiating portion, and a protruding portion. The first radiating portion forms a first current path, and the second radiating portion combined with the first radiating portion forms a second current path so as to generate different operating bands. The opening of the hollow portion is located between the second radiating and the protruding portions. Accordingly, the antenna module of the present invention is capable of operation according to Wireless Local Area Network (WLAN) standards.

An electronic device of the present invention comprises a wireless transmission module and the aforementioned antenna module, wherein the wireless transmission module is electrically connected to the antenna module. According to the arrangement of the aforementioned antenna module, the electronic device of the present invention is equipped with a wireless transmission function and is capable of connecting with either WiMAX or WLAN systems by associating with different antenna modules.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 illustrates a structure schematic drawing of an antenna module of a first embodiment of the present invention.

FIG. 2 illustrates a VSWR diagram of the antenna module of the first embodiment of the present invention.

FIG. 3 is a gain value table of the antenna module of the first embodiment of the present invention.

FIG. 4 illustrates a radiation pattern at 2.4 GHz of the antenna module of the first embodiment of the present invention.

FIG. 5 illustrates a radiation pattern at 3.7 GHz of the antenna module of the first embodiment of the present invention.

FIG. 6 illustrates a radiation pattern at 5.15 GHz of the antenna module of the first embodiment of the present invention.

FIG. 7 illustrates a schematic drawing of another usage mode of the antenna module of the first embodiment of the present invention.

FIG. 8(a) illustrates a structure schematic drawing of the antenna module of a second embodiment of the present invention.

FIG. 8(b) illustrates a structure schematic drawing of the antenna module of a third embodiment of the present invention.

FIG. 9 illustrates a structure schematic drawing of the antenna module of a fourth embodiment of the present invention.

FIG. 10 is a gain value table of the antenna module of the fourth embodiment of the present invention.

FIG. 11 illustrates a system block diagram of an electronic device of the present invention.

### DETAILED DESCRIPTION OF THE PREFERRED EMBODIMENT

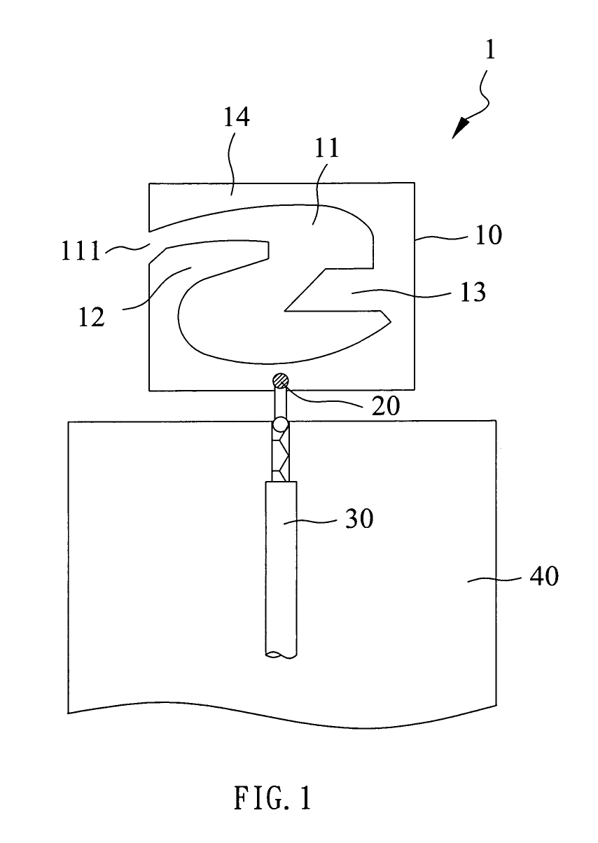

Please refer to FIG. 1. FIG. 1 illustrates a structural schematic drawing of an antenna module 1 of a first embodiment of the present invention. The antenna module 1 of the present invention is applied to an electronic device for transmitting wireless signals. As shown in FIG. 1, the antenna module 1 of the present invention comprises a main body 10 and a feed point 20. The main body 10 is a rectangular metal sheet and comprises a hollow portion 11. The hollow portion 11 extends inwardly from one side of the main body 10, and the hollow portion 11 comprises an opening 111. The main body 10 is separated by the hollow portion 11 to form a first radiating portion 12, a second radiating portion 13, and a third radiating portion 14. The opening 111 of the hollow portion 11 is located between the first radiating portion 12 and the third radiating portion 14. In this embodiment, the shape of the hollow portion 11 is substantially similar to the Arabic numeral 2, and the opening 111 refers to the beginning of the stroke of the 2.

The feed point 20 of the antenna module 1 of the present invention is connected to a feed line 30, such that electrical signals can be fed to the main body 10 via the feed line 30. The feed line 30 can be, but is not limited to, a coaxial cable. In this embodiment, the feed point 20 is set between the first radiating portion 12 and the second radiating portion 13. Further, the antenna module 1 of the present invention further comprises a ground element 40, which is electrically connected to the main body 10 and is used for providing a ground function. The main body 10 can be connected to the ground element 40 via the feed line 30. Alternatively, the ground element 40 can be directly connected to the main body 10. Please note that the method of connection between the main body 10 and the ground element 40 is not limited to the above description. The ground element 40 can be the casing of the electronic device, a metal plate, or a flexible metal material (such as a copper foil).

According to the design of the antenna module 1 of the present invention, the feed point 20 is a base point, such that the first radiating portion 12 forms a first current path when the electrical signal is fed to the first radiating portion 12; the second radiating portion 13 forms a second current path when the electrical signal is fed to the second radiating portion 13; and the third radiating portion 14 combined with the second radiating portion 13 forms a third current path when the electrical signal is fed to the third radiating portion 14 via the second radiating portion 13, so as to generate different operating bands. According to the structural design of the aforementioned antenna module 1 of the present invention, the first radiating portion 12 resonates a frequency band at around 5 GHz, the second radiating portion 13 resonates a frequency band at around 3 GHz, and the third radiating portion 14 combined with the second radiating portion 13 resonates a frequency band at around 2 GHz. Therefore, the antenna module 1 of the present invention is capable of functioning as a multi-band antenna.

As shown in FIG. 1, the width or the curvature of the hollow portion 11 of the antenna module 1 of the present invention can be adjusted, such that the first radiating portion 12, the second radiating portion 13, and the third radiating portion 14 will be adjusted accordingly. Because the difference of the shape, the width, or the length of each of the radiating portions may change the characteristics of the antenna, the designer can adjust each radiating portion by means of adjusting the hollow portion 11 so as to change the operating band of the antenna module 1 of the present invention. Further, by means of changing the position of the feed point 20, the length of the first current path, the second current path, or the third current path of the antenna module 1 of the present invention will be influenced to adjust the operating band of each of the radiating portions.

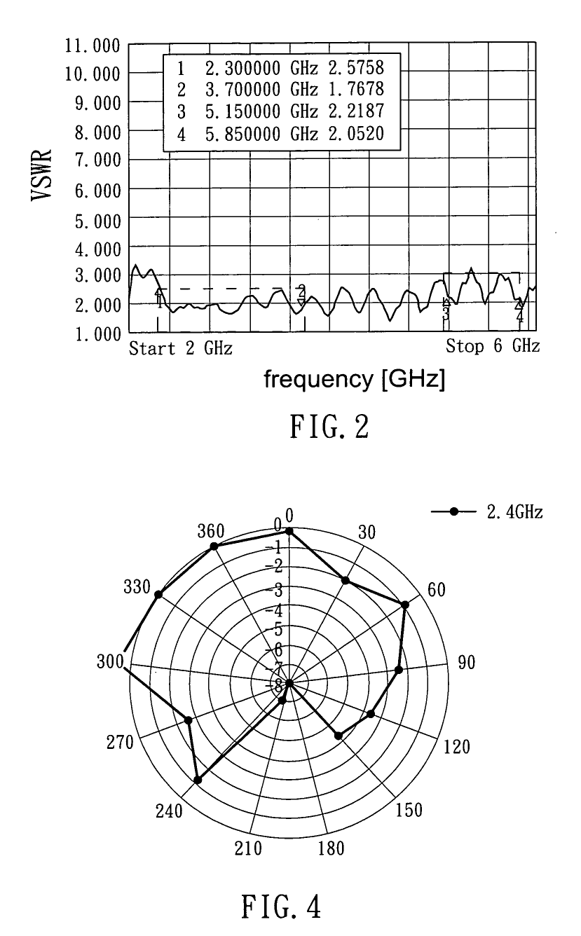

Please refer to FIG. 2. FIG. 2 illustrates a voltage standing wave ratio (VSWR) diagram of the antenna module 1 according to the first embodiment of the present invention. As shown in FIG. 2, the VSWR values of the antenna module 1 of the present invention are all less than 2.5 between the frequency bands of 2.3 GHz and 3.7 GHz, and the VSWR values of the antenna module 1 of the present invention are similar to or less than 3 between the frequency bands of 5.15 GHz and 5.85 GHz. Therefore, the antenna module 1 of the present invention achieves good transmission.

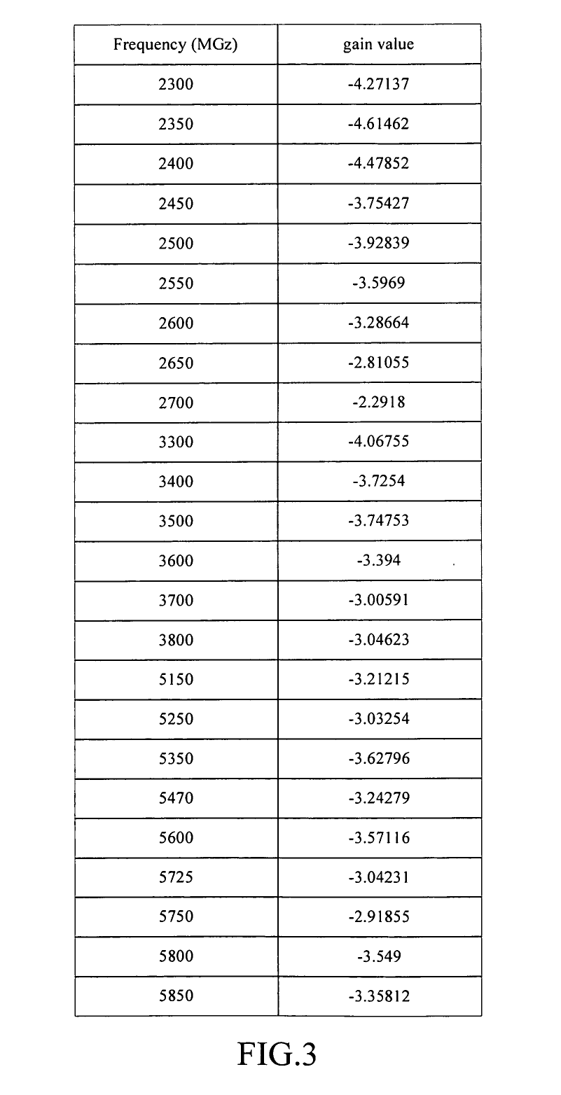

Please refer to FIG. 3. FIG. 3 is a gain value table of the antenna module 1 according to the first embodiment of the present invention. As shown in FIG. 3, the gain value table is recorded with gain values measured at commonly-used frequency bands between 2.3 GHz and 2.7 GHz, frequency bands between 3.3 GHz and 3.8 GHz, and frequency bands between 5.15 GHz and 5.85 GHz. According to the gain value table, most measured gain values are higher than −4, which may imply that the antenna module 1 of the present invention achieves high efficiency.

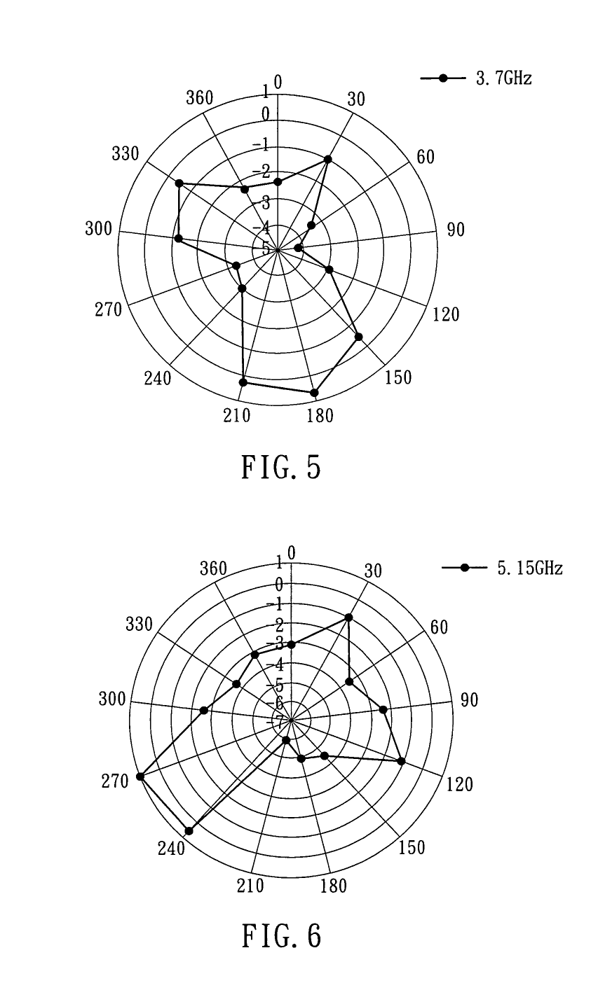

Please refer to FIGS. 4-6. FIG. 4 illustrates a radiation pattern at 2.4 GHz of the antenna module 1 of the first embodiment of the present invention. FIG. 5 illustrates a radiation pattern at 3.7 GHz of the antenna module 1 of the first embodiment of the present invention. FIG. 6 illustrates a radiation pattern at 5.15 GHz of the antenna module 1 of the first embodiment of the present invention. Please note that FIGS. 4-6 depict the gain values measured at every 30 degrees, wherein the radiation pattern between two adjacent measured gain values is depicted as a straight line. However, if the radiation pattern depicted the gain values measured at every 1 degree, the line of the radiation pattern would be a smooth curve. As shown in FIGS. 4-6, although the gain values of the antenna module 1 of the present invention measured at certain specific angles are barely satisfactory, at 2.4 GHz and 5.15 GHz, most gain values measured at other angles and frequency bands are still quite satisfactory. Therefore, the antenna module 1 of the present invention has an function similar to that of an omnidirectional antenna.

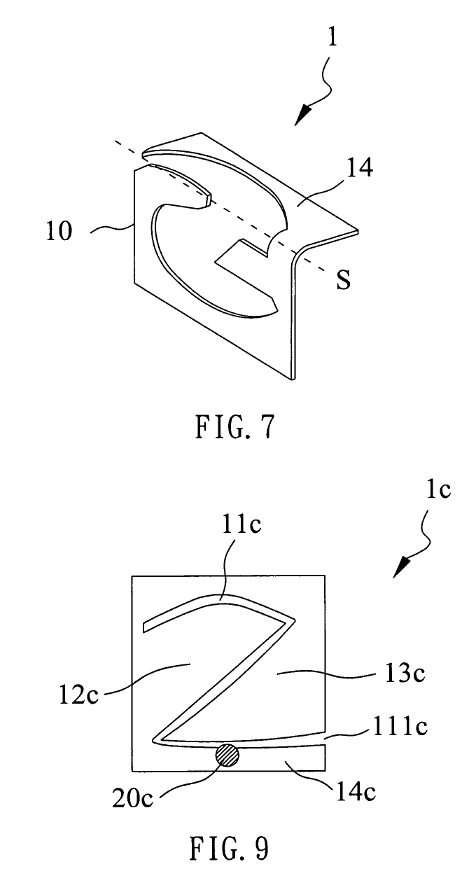

Please refer to FIG. 7. FIG. 7 illustrates a schematic drawing of another usage mode of the antenna module 1 according to the first embodiment of the present invention. In order to meet the demands of a compact and lightweight electronic device, the volume occupied by the antenna module 1 of the present invention can be reduced through a bending design, so as to conserve the available space of the electronic device. As shown in FIG. 7, in this embodiment, the antenna module 1 of the present invention fabricates a bending line S at an appropriate location of the main body 10, such that the third radiating portion 14 at the top end of the antenna module 1 can form a bending structure along the bending line S. In accordance with such a bending structure, the second radiating portion 13 and the third radiating portion 14 are connected with each other at a substantial 90-degree angle to reduce the size of the antenna module 1 of the present invention. Please note that the bending angle of the bending structure formed by the third radiating portion 13 is not limited to a substantial 90-degree angle.

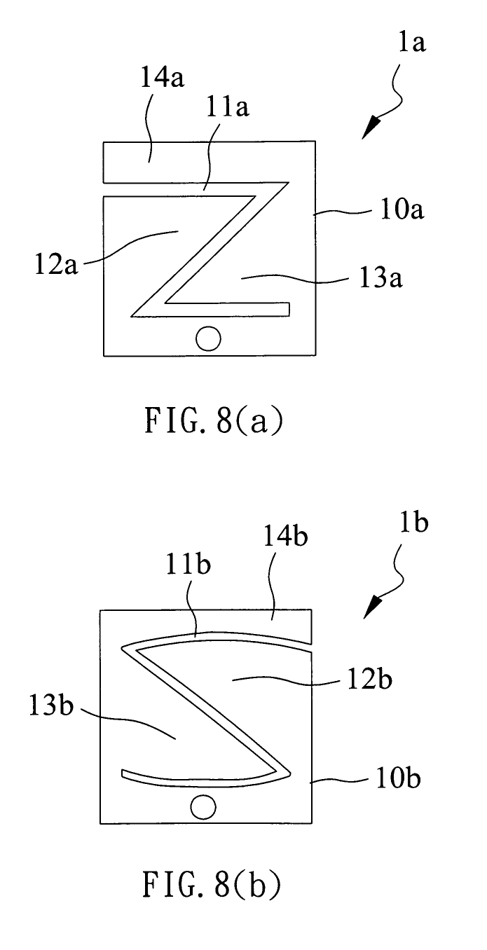

Please refer to FIG. 8(a) and FIG. 8(b). FIG. 8(a) illustrates a structural schematic drawing of the antenna module 1a of a second embodiment of the present invention. FIG. 8(b) illustrates a structure schematic drawing of the antenna module 1b of a third embodiment of the present invention. As shown in FIG. 8(a), the shape of the hollow portion 11a of the antenna module 1a of the present invention is similar to the English letter Z, such that the main body 10a is separated by the hollow portion 11a to form a first radiating portion 12a, a second radiating portion 13a, and a third radiating portion 14a. Therefore, the antenna module 1a of the present invention can also achieve a multi-band antenna function similar to that of the first embodiment. As shown in FIG. 8(b), the shape of the hollow portion 11b of the antenna module 1b of the present invention is similar to the English letter S. Although the overall structure of this embodiment is opposite to that of the second embodiment, the main body 10b can still be separated by the hollow portion 11b to form three radiating portions 12b, 13b, and 14b. Therefore, the antenna module 1b of the present invention can also achieve the multi-band antenna function.

Please refer to FIG. 9. FIG. 9 illustrates a structural schematic drawing of the antenna module 1c of a fourth embodiment of the present invention. The major difference between the fourth embodiment and the above embodiments is the location of the opening 111c of the hollow portion 11c. As shown in FIG. 9, the antenna module 1c of the present invention comprises the main body 10c and the feed point 20c. The main body 10c is a rectangular metal sheet and comprises a hollow portion 11c. The hollow portion 11c extends inwardly from one side of the main body 10c, and the hollow portion 11c comprises an opening 111c. The main body 10c is separated by the hollow portion 11c to form a first radiating portion 12c, a second radiating portion 13c, and a protruding portion 14c. The opening 111c of the hollow portion 11c is located between the second radiating portion 13c and the protruding portion 14c. In this embodiment, the shape of the hollow portion 11c is substantially similar to the Arabic numeral 2, and the opening 111c refers to the final end of the stroke of the numeral 2.

According to the design of the antenna module 1c of the present invention, the feed point 20c is a base point, such that the first radiating portion 12c forms a first current path when the electrical signal is fed to the first radiating portion 12c; and the second radiating portion 13c combined with the first radiating portion 12c forms a second current path when the electrical signal is fed to the second radiating portion 13c via the first radiating portion 12c, so as to generate different operating bands. Accordingly, the first radiating portion 12c resonates a frequency band at around 5 GHz, and the second radiating portion 13c combined with the first radiating portion 12c resonates a frequency band at around 2 GHz, so as to achieve a dual-band antenna function. Further, the shape of the hollow portion 11c of the antenna module 1c of the present invention can also be similar to the English letter S, the English letter Z, or the like to achieve a similar dual-band antenna function, rather than being limited to this embodiment.

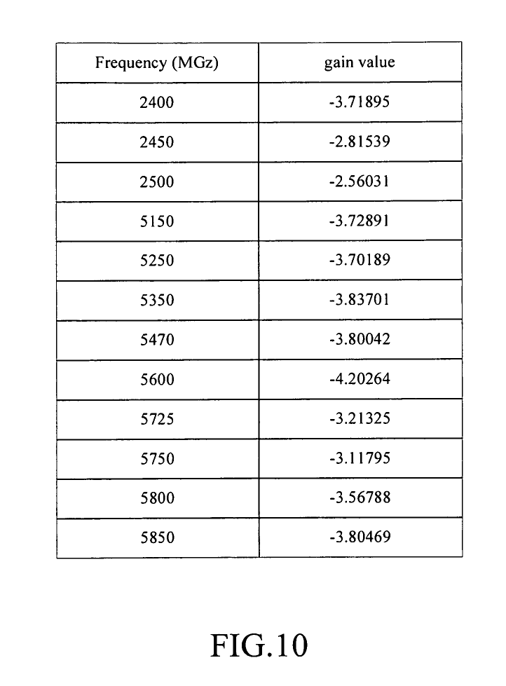

Please refer to FIG. 10. FIG. 10 is a gain value table of the antenna module 1c according to the fourth embodiment of the present invention. As shown in FIG. 10, the gain value table is recorded with gain values measured at commonly-used frequency bands between 2.4 GHz and 2.5 GHz, and frequency bands between 5.15 GHz and 5.85 GHz. According to the gain value table, most measured gain values are higher than −4, which may imply that the antenna module 1c of the present invention achieves high efficiency.

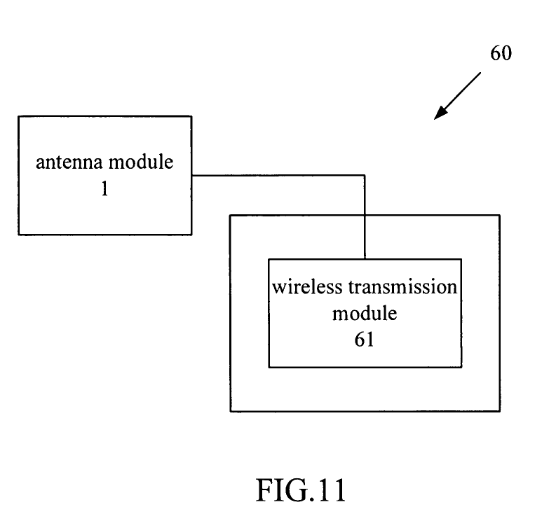

Please refer to FIG. 11. FIG. 11 illustrates a system block diagram of an electronic device 60 according to the present invention. In one embodiment of the present invention, the electronic device 60 can be a mobile device such as, but not limited to, a laptop computer or a cellular phone. As shown in FIG. 11, the electronic device 60 of the present invention comprises an antenna module 1 and a wireless transmission module 61. The electronic device 60 can utilize a feed line (not shown in FIG. 11) to feed into the antenna module 1, and is electrically connected to the wireless transmission module 61, such that the wireless transmission module 61 can process signals of the antenna module 1. For example, the wireless transmission module 61 can transmit or receive signals of the antenna module 1. As a result, the electronic device 60 can receive/transmit wireless signals from/to other devices (not shown in FIG. 11) via the antenna module 1, so as to achieve wireless communication function. Please note that the antenna module 1 of the electronic device 60 can be replaced by the antenna module 1a, 1b, 1c, or other equivalent antenna modules of the present invention, so as to receive/transmit wireless signals at different frequency bands.

Although the present invention has been explained in relation to its preferred embodiments, it is to be understood that many other possible modifications and variations can be made without departing from the spirit and scope of the invention as hereinafter claimed.

What is claimed is:

1. An antenna module for wireless signal transmission of an electronic device, the antenna module comprising:
a main body, which is a rectangular metal sheet and comprises a hollow portion, wherein the hollow portion extends inwardly from one side of the main body, such that the main body is separated by the hollow portion to form a first radiating portion, a second radiating portion, and a third radiating portion; and
a feed point, connected to a feed line, used for feeding an electrical signal to the main body;
wherein the first radiating portion forms a first current path, the second radiating portion forms a second current path, and the third radiating portion combined with the second radiating portion forms a third current path so as to generate different operating bands.

2. The antenna module as claimed in claim 1, wherein the hollow portion comprises an opening, which is located between the first radiating portion and the third radiating portion.

3. The antenna module as claimed in claim 2, wherein the shape of the hollow portion is substantially similar to the English letter Z, the English letter S, or the Arabic numeral 2.

4. The antenna module as claimed in claim 3, wherein the third radiating portion forms a bending structure.

5. The antenna module as claimed in claim 3, wherein the operating band of each of the radiating portions can be adjusted by means of changing the width or the curvature of the hollow portion.

6. The antenna module as claimed in claim 3, wherein the operating band of each of the radiating portions can be adjusted by means of changing the position of the feed point.

7. The antenna module as claimed in claim 1 further comprising a ground element, electrically connected to the main body, used for providing a ground function.

8. An electronic device with wireless transmission function, comprising a wireless transmission module and an antenna module, wherein the wireless transmission module is electrically connected to the antenna module, the antenna module comprising:
a main body, which is a rectangular metal sheet and comprises a hollow portion, wherein the hollow portion extends inwardly from one side of the main body, such that the main body is separated by the hollow portion to form a first radiating portion, a second radiating portion, and a third radiating portion; and
a feed point, connected to a feed line, used for feeding an electrical signal to the main body;
wherein the first radiating portion forms a first current path, the second radiating portion forms a second current path, and the third radiating portion combined with the second radiating portion forms a third current path so as to generate different operating bands.

9. The electronic device as claimed in claim 8, wherein the hollow portion comprises an opening, which is located between the first radiating portion and the third radiating portion.

10. The electronic device as claimed in claim 9, wherein the shape of the hollow portion is substantially similar to the English letter Z, the English letter S, or the Arabic numeral 2.

11. The electronic device as claimed in claim 10, wherein the third radiating portion forms a bending structure.

12. The electronic device as claimed in claim 10, wherein the operating band of each of the radiating portions can be adjusted by means of changing the width or the curvature of the hollow portion.

13. The electronic device as claimed in claim 10, wherein the operating band of each of the radiating portions can be adjusted by means of changing the position of the feed point.

14. The electronic device as claimed in claim 8 further comprising a ground element, electrically connected to the main body, used for providing a ground function.

15. An antenna module for wireless signal transmission of an electronic device, the antenna module comprising:
a main body, which is a rectangular metal sheet and comprises a hollow portion, wherein the hollow portion extends inwardly from one side of the main body, such that the main body is separated by the hollow portion to form a first radiating portion, a second radiating portion, and a protruding portion; and
a feed point, connected to a feed line, used for feeding an electrical signal to the main body;
wherein the first radiating portion forms a first current path, and the second radiating portion combined with the first radiating portion forms a second current path so as to generate different operating bands.

16. The antenna module as claimed in claim 15, wherein the hollow portion comprises an opening, which is located between the second radiating portion and the protruding portion.

17. The antenna module as claimed in claim 16, wherein the shape of the hollow portion is substantially similar to the English letter Z, the English letter S, or the Arabic numeral 2.

18. The antenna module as claimed in claim 17, wherein the second radiating portion forms a bending structure.

19. The antenna module as claimed in claim 17, wherein the operating band of each of the radiating portions can be adjusted by means of changing the shape or the curvature of the hollow portion.

20. The antenna module as claimed in claim 17, wherein the operating band of each of the radiating portions can be adjusted by means of changing the position of the feed point.

21. The antenna module as claimed in claim 15 further comprising a ground element, electrically connected to the main body, used for providing a ground function.

22. An electronic device with wireless transmission function, comprising a wireless transmission module and an antenna module, wherein the wireless transmission module is electrically connected to the antenna module, the antenna module comprising:
a main body, which is a rectangular metal sheet and comprises a hollow portion, wherein the hollow portion extends inwardly from one side of the main body, such that the main body is separated by the hollow portion to form a first radiating portion, a second radiating portion, and a protruding portion; and
a feed point, connected to a feed line, used for feeding an electrical signal to the main body;
wherein the first radiating portion forms a first current path, and the second radiating portion combined with the first radiating portion forms a second current path so as to generate different operating bands.

23. The electronic device as claimed in claim 22, wherein the hollow portion comprises an opening, which is located between the second radiating portion and the protruding portion.

24. The electronic device as claimed in claim 23, wherein the shape of the hollow portion is substantially similar to the English letter Z, the English letter S, or the Arabic numeral 2.

25. The electronic device as claimed in claim 24, wherein the second radiating portion forms a bending structure.

26. The electronic device as claimed in claim 24, wherein the operating band of each of the radiating portions can be adjusted by means of changing the shape or the curvature of the hollow portion.

27. The electronic device as claimed in claim 24, wherein the operating band of each of the radiating portions can be adjusted by means of changing the position of the feed point.

28. The electronic device as claimed in claim 22 further comprising a ground element, electrically connected to the main body, used for providing a ground function.
